(19) United States
(12) Patent Application Publication
(10) Pub. No.: US 2016/0009880 A1
(43) Pub. Date: Jan. 14, 2016

(54) STRETCH FILM

(71) Applicants: SATO HOLDINGS KABUSHIKI KAISHA, Tokyo (JP); ACTEIIVE CORPORATION, Noda City (JP)

(72) Inventors: Masahiko ABE, Noda City (JP); Masamitsu NAGAHAMA, Kitakatsushikagun (JP); Shigeru KIDO, Ishikawa-Gun (JP); Akira SATO, Noda City (JP); Masatoshi TAKAHASHI, Noda City (JP); Yoshito FUJII, Tokyo (JP); Hiromi YAMAMURO, Tokyo (JP); Yoshihisa YAMAUCHI, Tokyo (JP)

(21) Appl. No.: 14/753,502

(22) Filed: Jun. 29, 2015

(30) Foreign Application Priority Data
Jun. 30, 2014 (JP) 2014134922

(51) Int. Cl. C08J 5/18; C08K 9/10; B29C 47/00

(52) U.S. Cl. CPC C08J 5/18; B29C 47/0004; C08K 9/10; B29K 2023/00

(57) ABSTRACT

A novel film material that is capable of reducing an amount of carbon dioxide discharged during incineration for disposal is provided. The novel film material is a stretch film formed to a thickness in a range of 5 to 50 μm. The stretch film contains a thermoplastic resin composition that includes a carbon dioxide absorbing substance in an amount in a range of 0.1 to 10 wt %.

### BACKGROUND OF THE INVENTION

1. Field of the Invention

The present disclosure relates to a film material that may reduce an amount of carbon dioxide discharge at a time of combustion. In particular, stretch film packaging with an objective of preventing a load shift or protection of an item to be transported, or a method of producing thereof. In addition, the present disclosure relates to a method of employing the stretch film and a method of reducing an amount of carbon dioxide discharged using the stretch film.

2. Description of the Related Art

A stretch film having stretchability is widely used as a wrapping material or packing material. In particular, a packaging stretch film may be used for preventing a load shift or protection of products loaded onto a pallet. The stretch film has superior elasticity and adhesiveness for stable wrapping of a product, and has sufficient strength such that product damage may be prevented. A film containing a polyolefin film, a polyester-based film, a polyvinyl chloride-based film, or a multilayered structure laminated with a film composed of a polyolefin film, a polyester-based film, or a polyvinyl chloride-based may be used as the stretch film having the above properties.

Products composed of such a film are processed for disposal by reclamation or combustion after usage. However, recently the problem of discharging a greenhouse gas in large quantities by combustion of a plastic product that includes a film product has been extensively covered. As an attempt to reduce a load imposed on the environment in a case where a film product is disposed of as waste, a thin stretch film (JP-A 2012-171141), a stretch film that uses a biodegradable polyester such as polyactic acid (JP-A 2008-169239), or the like, has been proposed. However, maintaining film strength while decreasing a thickness thereof is difficult. And, there are many cases where a multilayered film structure is needed. On the other hand, a biodegradable polymer is known that the film formability is somewhat poor.

A policy that attempts to reduce an environmental load resulting from a greenhouse gas discharged by such a film product requires a new viewpoint that is different from a conventional one.

### SUMMARY OF INVENTION

A present disclosure was accomplished in view of an existing problem in the art. In other words, the present disclosure is for the purpose of proposing a novel film material that is capable of reducing an amount of carbon dioxide discharged in a case of incineration disposal.

Moreover, a present disclosure is for a purpose of proposing a production method for such a film material. Further, a present disclosure is for a purpose of proposing a method of using such a film material as a product packaging stretch film, and a method of reducing an amount of carbon dioxide discharged by using a film material.

### DETAILED DESCRIPTION

A first embodiment of a present disclosure describes a stretch film. The stretch film includes a thermoplastic resin composition having a thickness in a range of 5 to 50 μm, the thermoplastic resin composition containing a carbon dioxide absorbing substance in an amount in a range of 0.1 to 10 wt %. The stretch film of the present disclosure possesses pliability, elasticity, transparency, strength such that breakage or the like does not occur even during elongation, binding properties, and suitability for product wrapping or packaging. The stretch film of a first embodiment of the present disclosure is formed of a thermoplastic resin composition that contains a carbon dioxide absorbing substance in an amount in a range of 0.1 to 10 wt %. The carbon dioxide absorbing substance refers to a substance having a structure that allows the absorption or fixation thereof via a chemical reaction with carbon dioxide as a representative greenhouse gas or a substance having a structure that allows carbon dioxide to be physically absorbed and fixed within an inner gap or the like. The carbon dioxide absorbing substance may be a solid or liquid. The carbon dioxide absorbing substance is included in an amount in a range of 0.1 to 10 wt %, and more preferably in an amount in a range of 0.1 to 5 wt %, based on the weight of the thermoplastic resin composition. In a case where the amount of the carbon dioxide absorbing substance exceeds 10 wt %, a film forming property of the thermoplastic resin composition is inferior or a strength of a manufactured film may be reduced. Further, in a case where the amount of the carbon dioxide absorbing substance is less than 0.1 wt %, there is a risk that the absorbability of carbon dioxide may be insufficient. In particular, a stretch film formed from a thermoplastic resin composition that contains a carbon dioxide absorbing substance in an amount of 0.1 to 5 wt % is advantageous in having superior breaking strength or tearing strength when compared to a stretch film formed using a thermoplastic resin that does not include a carbon dioxide in an amount of 0.1 to 5 wt %. The thickness of the stretch film is in a range of 5 to 50 μm, and more preferably in a range of 10 to 30 μm. In a case where the thickness of the stretch film exceeds 50 μm, the strength of the stretch film is high, but the product wrapping or packaging workability is reduced because an elongation property of the film is reduced. Further, increasing the thickness of the film also means increasing the amount of waste during disposal. Moreover, in a case where the thickness of the stretch film is less than 5 μm, the strength of the stretch film may not be maintained. Accordingly, there is a risk that the product may not be suitably protected in case where the product is wrapped or packaged.

Metal hydroxide, metal oxide, aluminum silicate salt, titanic acid compound, lithium silicate salt, or a mixture of two or more thereof may be exemplified as the carbon dioxide absorbing substance in the first embodiment. Sodium hydroxide, calcium hydroxide, lithium hydroxide, magnesium hydroxide, or barium hydroxide may be exemplified as the metal hydroxide. Magnesium oxide, calcium oxide, potassium oxide, or zinc oxide may be exemplified as the metal oxide. Moreover, aluminosilicate or zeolite may be exemplified as the aluminum silicate salt. Barium titanate or orthobarium titanate may be exemplified as the titanic acid compound. Lithium silicate may be exemplified as the lithium silicate salt. In addition thereto, a carbon dioxide absorbing substance of an organic compound may also be suitably employed, e.g., a potassium terephthalate pyrolysis product or a coconut mesocarp fiber. Moreover, a thermoplastic resin employed in a first embodiment may be any resin so long as a film that is formed possesses pliability, extensibility, elongation strength, binding properties, or the like, that are suitable for application as a stretch film. Polyolefin, polyester, polyvinyl chloride, ethylene-vinyl acetate copolymer, or the like, or any combination of two or more of these may be employed as the thermoplastic resin. As an additional ingredient, a conventionally employed dispersing agent, plasticizer, stabilizer, lubricant, thickener, adhesive, anti-static agent, or anti-blocking agent may be suitably combined and employed as an auxiliary agent for improving film product performance or a processing agent for simplifying film production, as necessary.

A second embodiment of a present disclosure describes a stretch film production method of producing a thermoplastic resin composition by mixing a thermoplastic resin with a carbon dioxide absorbing substance in an amount in a range of 0.1 to 10 wt %, and forming the thermoplastic resin composition to a thickness in a range of 5 to 50 μm by an inflation molding method. First, the thermoplastic resin composition is produced by mixing a thermoplastic resin and a carbon dioxide absorbing substance. At such a time, the carbon dioxide absorbing substance is prepared such that the carbon dioxide absorbing substance is included in an amount in a range of 0.1 to 10 wt %, and more preferably in an amount in a range of 0.1 to 5 wt %, based on the weight of the thermoplastic resin composition. A mixture of thermoplastic resin and carbon dioxide absorbing substance may be optionally selected in response to a property or an amount of the thermoplastic resin composition to be produced by a means that is typically employed in resin composition production. For example, various types of mixers, various types of feeders, or various types of agitators may be employed. The mixing of the thermoplastic resin and the carbon dioxide absorbing substance may be performed within a range of room temperature to 400° C., and more preferably within a range of 100 to 250° C., which is a suitable temperature for the employed thermoplastic resin. In a case where mixing the thermoplastic resin and the carbon dioxide absorbing substance, it is also possible to first produce a master batch by mixing a specified amount of the carbon dioxide absorbing substance and a small amount of the thermoplastic resin, and then to mix the residual amount of the thermoplastic resin with the obtained master batch. The carbon dioxide absorbing substance may be more uniformly dispersed into the thermoplastic resin by mixing the carbon dioxide absorbing substance and the thermoplastic resin in a plurality of stages.

The stretch film is produced using the thermoplastic resin composition that is produced in the above described manner. The production of the stretch film may employ any method for forming a film product. For example, an extrusion molding method, a T-die method, an inflation molding method, a fusion-casting method, or a calendar method, may be employed. However, an inflation molding method or a T-die method of a second embodiment of the present disclosure is preferable. The inflation molding method is a production method of continuously forming a cylindrical film by blowing a thermoplastic resin composition extruded from an extruder upwardly through an annular-shaped die. The T-die method is a production method of forming a thin film by extrusion of a thermoplastic resin composition extruded from an extruder via a slit. The inflation molding method and the T-die method are typically employed in a case where producing a wrapping film, a bag, an industrial film, or the like. It is preferable that thickness of the stretch film is formed to be in a range of 5 to 50 μm, and more preferably formed to be in a range of 10 to 30 μm, by selectively controlling the conditions of the inflation molding method and the T-die method.

Melt Flow Rate (MFR) is an important thermoplastic resin composition property in a case where a thermoplastic resin composition is used to form a stretch film shape by the inflation molding method or the T-die method. In a case where a value of the MFR is too small, a disadvantage exists where the thermoplastic resin composition may not be stretched thin. In a case where a value of the MFR is too large, a disadvantage exists where the thermoplastic resin composition is unmoldable (the thermoplastic resin composition breaks as a result of being too mushy). Therefore, the molding and processing properties are reduced by a thermoplastic resin composition inflation molding method or a T-die method. As a result, efficiently producing the stretch film of the first embodiment may be difficult. An MFR of a thermoplastic resin composition suitable for production of a stretch film by the inflation molding method or the T-die method is in a range of 0.01 to 10 g/10 minutes, and more preferably 0.01 to 5 g/10 minutes. It is important that amount of carbon dioxide absorbing substance in the thermoplastic resin composition is in a range of 0.1 to 10 wt %, and more preferably in a range of 0.1 to 5 wt %, based on the weight of the thermoplastic resin composition. In a case where the carbon dioxide absorbing substance is maintained within the abovementioned specified range, film formation is simplified by the inflation molding method or the T-die method. The stretch film produced by the inflation molding method or the T-die method typically forms a product that is wound into a rolled shape. But, depending on a usage of the stretch film, the stretch film may also be stored in the shape of a sheet by specifying the size of the cut from the roll, or the like.

In a case where mixing the carbon dioxide absorbing substance with the thermoplastic resin in the second embodiment, it is preferable that the mixing is such that carbon dioxide absorbing substance is incorporated into a lipid bilayer of an amphipathic lipid. An amphipathic lipid is a lipid that has a hydrophilic group and a lipophilic group within a single molecule. A phospholipid may be exemplified as an example of an amphipathic lipid. For example, phosphatidylcholine, dimyristoylphosphatidylcholine, phosphatidylethanolamine, phosphatidylinositol, phosphatidylglycerol, diphosphatidylglycerol, or sphingomyelin may be exemplified. It is possible for the amphipathic lipid to form a lipid bilayer in water or an organic solvent via self-organization, and to mix the carbon dioxide absorbing substance with thermoplastic resin such that the carbon dioxide absorbing substance is incorporated into the lipid bilayer. Accordingly, it is possible to have the carbon dioxide absorbing substance more uniformly dispersed in the thermoplastic resin composition.

A metal hydroxide, a metal oxide, an aluminum silicate salt, a titanic acid compound, a lithium silicate salt, or a combination employing two or more thereof may be employed as the carbon dioxide absorbing substance in the second embodiment. Sodium hydroxide, calcium hydroxide, lithium hydroxide, magnesium hydroxide, or barium hydroxide may be exemplified as the metal hydroxide. Magnesium oxide, calcium oxide, potassium oxide, or zinc oxide may be exemplified as the metal oxide. Moreover, aluminosilicate or zeolite may be exemplified as the aluminum silicate salt. Barium titanate or orthobarium titanate may be exemplified as the titanic acid compound. Lithium silicate may be exemplified as the lithium silicate salt. In addition thereto, a carbon dioxide absorbing substance of an organic compound may also be suitably employed, e.g., a potassium terephthalate pyrolysis product or a coconut mesocarp fiber. Moreover, a thermoplastic resin employed in a second embodiment may be any resin so long as a film that is formed possesses pliability, extensibility, elongation strength, binding properties, or the like, that are suitable for application as a stretch film. Polyolefin, polyester, polyvinyl chloride, ethylene-vinyl acetate copolymer, or the like, or a combination of two or more thereof may be employed as the thermoplastic resin. As an additional ingredient, a conventionally employed dispersing agent, plasticizer, stabilizer, lubricant, thickener, adhesive, anti-static agent, or anti-blocking agent may be suitably combined and employed as an auxiliary agent for improving film product performance or a processing agent for simplifying film production, as necessary.

A third embodiment of the present disclosure describes a stretch film usage method of wrapping or packaging a product using a stretch film that includes a thermoplastic resin composition having a carbon dioxide absorbing substance in an amount in a range of 0.1 to 10 wt %, in which the stretch film is formed to a thickness in a range of 5 to 50 Because the stretch film of a first embodiment of the present disclosure possesses pliability, extensibility, elongation strength, and binding properties, the stretch film may be employed in the wrapping or packaging of a product. Although the stretch film of the first embodiment may be used to wrap any product, e.g., food products, eating implements, stationary, publications, or general goods, it is especially preferable that the stretch film of the first embodiment be used in the wrapping and packaging of an item for transport that is loaded onto a pallet. The stretch film of the first embodiment may suitably wrap a relatively large volume product in the same way as an item for transport that is loaded onto a pallet, and improve transportation efficiency by preventing a load shift in an item. Because the stretch film of the first embodiment has sufficient strength, excessive winding is not required in a case where wrapping an item for transport. For example, if wrapped one time, two times, or at the most three times, a load shift may be effectively prevented. In a case where using the stretch film of the first embodiment to wrap the item for transport, the amount of waste may be reduced at the time of disposal, as a result of a reduction in the amount of the stretch film used.

A fourth embodiment of the present disclosure describes a method of reducing an amount of carbon dioxide discharge, the method including absorbing a carbon dioxide discharged by combusting a stretch film formed to a thickness in a range of 5 to 50 μm, which includes a thermoplastic resin composition containing a carbon dioxide absorbing substance in an amount in a range of 0.1 to 10 wt %. The thermoplastic resin included as the main component of the stretch film of the first embodiment of the present disclosure discharges the carbon dioxide by combustion. And, the discharged carbon dioxide is absorbed and fixed to the carbon dioxide substance contained in the stretch film, and an incineration residue is formed. Therefore, part or all of the carbon dioxide discharged by combustion of the thermoplastic resin is fixed within the carbon dioxide absorbing substance. Accordingly, an amount of carbon dioxide discharged may be reduced in a case where incinerating the stretch film of the first embodiment as waste. Further, even if combustion were performed together with mixing at the time of incineration of the stretch film of the first embodiment as waste, it would be possible to reduce the carbon dioxide discharge from the overall waste. Thus, it would be possible to also contribute to a reduction in an amount of carbon dioxide discharged at an entire incineration plant. In other words, even in a case where performing waste treatment of the stretch film of the first embodiment for thermal recycling, the amount of the carbon dioxide that is discharged is significantly reduced. Thus, it is possible to achieve energy recovery along with a reduction in an environmental load.

A stretch film of the present disclosure that is superior in tensile strength and tearing strength may be more efficiently produced by the inflation molding method or the T-die method, in particular. The stretch film of the present disclosure may be advantageously employed in the wrapping or packaging of various products that include an item for transport that is loaded onto a pallet. Moreover, in a case where the stretch film of the present disclosure is incineration processed as product for disposal, it is possible to reduce the amount of carbon dioxide that is discharged and to reduce the load imposed upon the environment.

An example of the stretch film of the first embodiment of the present disclosure will be described hereinafter.

The stretch film formed to have a thickness in a range of 5 to 50 μm includes a thermoplastic resin composition that contains a carbon dioxide absorbing substance in an amount in a range of 0.1 to 10 wt %. Metal hydroxide, metal oxide, aluminum silicate salt, titanic acid compound, lithium silicate salt or any combination of at least two or more thereof may be exemplified as the carbon dioxide absorbing substance. Sodium hydroxide, calcium hydroxide, lithium hydroxide, magnesium hydroxide, or barium hydroxide may be exemplified as the metal hydroxide. Magnesium oxide, calcium oxide, potassium oxide, or zinc oxide may be exemplified as the metal oxide. Moreover, aluminosilicate or zeolite may be exemplified as the aluminum silicate salt. Barium titanate or othrobarium titanate may be exemplified as the titanic acid compound. Lithium silicate may be exemplified as the lithium silicate salt. In addition thereto, a carbon dioxide absorbing substance of an organic compound may also be suitably employed, e.g., a potassium terephthalate pyrolysis product or a coconut mesocarp fiber. When considering a simplified mixture for the thermoplastic resin or simplified handling of the carbon dioxide absorbing substance itself, it is preferable that calcium hydroxide, barium titanate, aluminosilicate, or lithium silicate salt are employed, in particular. Any resin may be employed as the thermoplastic resin so long as a film may be formed that possesses pliability, extensibility, elongation strength, binding properties, etc., suitable for application as a stretch film. For example, polyolefin, polyester, polyvinyl chloride, ethylene-vinyl acetate copolymer, or a combination of two or more thereof may be employed as the thermoplastic resin. From a perspective of achieving superior balance between all the properties that suitably employed for a stretch film, usage of a polyolefin that is a polymer of α-olefin, in particular, usage of polyethylene (low density polyethylene, high density polyethylene, super low density polyethylene, linear low density polyethylene, ultra high molecular weight polyethylene), polypropylene (isotactic polypropylene, syndiotactic polypropylene, atactic polypropylene); polyester (polyethylene terephthalate, polybutylene terephthalate, polyethylene naphthalate, polybutylene naphthalate); polyvinyl chloride; or ethylene-vinyl acetate copolymer is particularly preferable.

In a case where mixing the carbon dioxide absorbing substance and the thermoplastic resin, the mixing may be performed in a range of room temperature to 400° C., and more preferably in a range of 100 to 250° C. In a case of mixing, mixing devices (various types of mixers, various types of feeders, or various types of agitators) may be employed, which are employed at a conventional resin production site. In a case where mixing the thermoplastic resin and the carbon dioxide absorbing substance, it is preferable that a master batch is first produced by mixing a specified amount of the carbon dioxide absorbing substance and a small amount of the thermoplastic resin, and a residual amount of the thermoplastic resin is then mixed with the obtained master batch. Further, in a case where mixing the carbon dioxide absorbing substance with the thermoplastic resin, it is particularly preferable that the mixing is such that carbon dioxide absorbing substance is incorporated into a lipid bilayer of an amphipathic lipid. A phospholipid may be exemplified as an example of a suitably employed amphipathic lipid. For example, phosphatidylcholine, dimyristoylphosphatidylcholine, phosphatidylethanolamine, phosphatidylinositol, phosphatidylglycerol, diphosphatidylglycerol, or sphingomyelin may be employed. It is extremely preferably that the mixing between the carbon dioxide absorbing substance and the thermoplastic resin occurs while the carbon dioxide absorbing substance is incorporated into an amphipathic lipid that is formed by self-organization with a lipid bilayer in water or an organic solvent.

The stretch film is formed of the thermoplastic resin composition obtained in the above-described manner. A production of the stretch film may employ any method so long as a film product is formed. For example, an extrusion molding method, a fusion-casting method, a calendar method, or T-die method may be employed. However, an inflation molding method or a T-die method is particularly preferable. By selectively controlling the conditions of the inflation molding method or the T-die method, the thickness of the stretch film may be formed in a range of 5 to 50 μm, and more preferably in a range of 10 to 30 μm.

The obtained stretch film is employed in the wrapping or packaging of a product. Although the stretch film may be used to wrap any product, e.g., food products, eating implements, stationary, publications, or general goods, the properties of the stretch film may be particularly advantageous in a case of wrapping and packaging an item for transport that is loaded onto a pallet. A loaded item for transport may be stabilized by winding the stretch film around the periphery of the item for transport, e.g., one time, two times, or three times, either by hand or by machine. After transport of the item has been completed, the stretch film is removed and processed for disposal in accordance with the local ordinances of each region.

In many local municipalities a treatment of plastic for disposal is by incineration or reclamation. In particular, incineration treatment is a typical waste treatment method. In a case where combusting the stretch film that contains the carbon dioxide absorbing substance, part or all of the carbon dioxide discharged by combustion is incorporated and fixed within the carbon dioxide absorbing substance. In other words, the amount of the carbon dioxide that is discharged in a case combustion of the stretch film is reduced. Thus, the stretch film is considered to be a more environmentally friendly product.

### EXAMPLES

### Example 1

### Production of Stretch Film

A thermoplastic resin composition for producing stretch film is produced in accordance with an Example disclosed in JP-A 2013-122020. The details will be described hereinafter.

### 1. Production of Carbon Dioxide Absorbing Substance

Sodium aluminate 6 g (Wako Pure Chemical Industries, Ltd.; Wako Special Grade) and sodium silicate 30 g were dissolved in water 130 grams, then agitated for 60 minutes at 30° C. After agitation, an amorphous sodium aluminosilicate was produced by centrifugation. The obtained sodium aluminosilicate was a porous material. The sodium aluminosilicate was a carbon dioxide absorbing substance used as described hereinafter.

### 2. Crystal Nucleating Agent

Sodium 2,2′-methylene-bis-(4,6-di-tert-butylphenyl)phosphate (ADEKA CORPORATION; NA-11) was used as a crystal nucleating agent of a polyolefin-based resin.

### 3. Production of Liposome

A liposome containing the amorphous sodium aluminosilicate and sodium 2,2′-methylene-bis-(4,6-di-tert-butylphenyl)phosphate was produced by a supercritical reverse phase evaporation method and device. Inside a high pressure stainless steel container, 0.6 g of sodium aluminosilicate phosphatidylcholine with an average particle diameter of 10 to 50 nm, 0.6 g of sodium 2,2′-methylene-bis-(4,6-di-tert-butylphenyl)phosphate with an average particle diameter of 10 to 500 nm, 5 parts by weight. of phosphatidylcholine as a phospholipid, and 100 parts by weight. of deionized water were placed, sealed, and stored at 60° C. A supercritical state was obtained by injecting carbon dioxide at a pressure of 20 MPa. The mixture was agitated for 20 minutes while the temperature and pressure were maintained. Afterwards, a supercritical process was performed to restore atmospheric pressure by discharging carbon dioxide. As a result, a liquid was obtained that contained a liposome that incorporated the sodium aluminosilicate and the sodium 2,2′-methylene-bis-(4,6-di-tert-butylphenyl)phosphate in phosphatidylcholine. The carbon dioxide in a supercritical state refers to carbon dioxide that is in a supercritical state at or above a critical temperature (30.98° C.) and a critical pressure (7.3773±0.0030 MPa). A carbon dioxide temperature or pressure condition equal to or above the critical point refers to carbon dioxide under a condition where only the critical temperature or the critical pressure exceeds a criticality thereof (however, in such a case, the critical temperature and the critical pressure do not both exceed the criticality thereof).

### 4. Production of Thermoplastic Resin Composition

A high density polyethylene (Prime Polymer Co., Ltd.; HI-ZEX 5000 SF) was used as the polyolefin-based resin. The liposome 30 g (produced as previously described) and a high density polyethylene pellet 1 kg were placed inside of a mixer (KAWATA MFG CO., Ltd.; SMV-200), and agitated for 5 minutes at 1000 rpm while being heated to 60° C. During the abovementioned time period, the liposome was destroyed by friction or collision resulting from agitation. As a result, the phospholipid that is a membrane-enclosed component of the liposome acting as a dispersing agent, the sodium aluminosilicate acting as the carbon dioxide absorbing agent (stored) incorporated in the liposome, and the sodium 2,2′-methylene-bis-(4,6-di-tert-butylphenyl)phosphate acting as a crystal nucleating agent of high density polyethylene were widely dispersed across the surfaces of various high density polyethylene pellets. Next, kneaded was performed at 1500 rpm and under a resin temperature of 180° C. using a twin screw extruder (TECHNOVEL CORPORATION; KZW32TW-30/45MG-NH). A thermoplastic resin composition was obtained that contained a high density polyethylene that had a phospholipid resulting from a destroyed nano-capsule liposome and a general additive nucleating agent that were uniformly dispersed at a nano-order level via pelletization. The carbon dioxide absorbing substance (sodium aluminosilicate) 0.58 wt % was included in the thermoplastic resin composition.

### 5. Production of Stretch Film

The obtained pellet was used to form a stretch film that had a thickness of 12 μm by an inflation molding device.

### 6. Measurement of Breaking Strength and Tearing Strength

A breaking strength along a machine direction (MD) of the resin of the stretch film and along the transverse direction (TD) of the resin of the stretch film produced by a method similar to that in the abovementioned “5,” was measured by JIS Z1702. And, similarly, a tearing strength along a machine direction (MD) of the resin of the stretch film and along the transverse direction (TD) of the resin of the stretch film was measured via ISO6383-1 and ISO6383-2. First, the breaking strength (MD and TD) and the tearing strength (MD and TD) were similarly measured (see, Table 1, 0 wt % content of carbon dioxide absorbing substance), using a film formed to an identical thickness as a thermoplastic resin high density polyethylene that lacked sodium aluminosilicate and sodium 2,2′-methylene-bis-(4,6-di-tert-butylphenyl)phosphate (as the carbon dioxide absorbing substance), as a reference.

Similarly, based on the weight of the thermoplastic resin composition, 0.1 wt %, 3 wt %, 5 wt %, and 10 wt % of the sodium aluminosilicate were each prepared as the carbon dioxide absorbing substance, and the stretch film was similarly formed. As previously described, the breaking strength and the tearing strength (MD and TD) were similarly measured.

TABLE 1
Table 1: Breaking strength and tearing strength of stretch film

| Carbon dioxide | | | |
|---|---|---|---|
| absorbing substance | Direction of | | |
| content | strength | Breaking strength | Tearing strength |
| (wt %) | measurement | (MPa) | (MPa) |
| 0 | MD | 35.0 | 121.0 |
| | TD | 20.0 | 162.0 |
| 0.1 | MD | 36.8 | 127.1 |
| | TD | 21.0 | 170.1 |
| 3.0 | MD | 42.0 | 145.2 |
| | TD | 24.0 | 194.4 |
| 5.0 | MD | 40.3 | 139.2 |
| | TD | 23.0 | 186.3 |
| 10.0 | MD | 28.0 | 96.8 |
| | TD | 16.0 | 129.6 |

MD: Machine direction of resin
TD: Transverse direction of resin

Based on a result of Table 1, the stretch film of the present disclosure that includes sodium aluminosilicate as the carbon dioxide absorbing substance also increases the breaking strength and the tearing strength when compared to an existing high density polyethylene film product. In particular, a stretch film produced from a polyethylene composition containing approximately 3 wt % of sodium aluminosilicate was found to remarkably improve the breaking strength and the tearing strength. On the other hand, while a stretch film produced from a polyethylene composition containing 10 wt % of sodium aluminosilicate was found to reduce the breaking strength and the tearing strength when compared to an existing high density polyethylene film product, the strength required for use as a stretch film was still maintained.

### Example 2

### Film Forming Property of Stretch Film

Workability may be estimated by the MFR in a case where producing a film with a thermoplastic resin composition by an inflation molding method or a T-die method. The MFR of each thermoplastic resin composition produced in Example 1 was measured by a method disclosed in ISO1133-1 and ISO1133-2. The MFR value of each thermoplastic resin composition produced in Example 1 was within a range that allowed film production by either the inflation molding method or the T-die method.

It was found that the production of film by the inflation molding method or T-die method was not impaired even in a case where an amount of the carbon dioxide absorbing substance in the thermoplastic resin composition was within a range of 0.1 to 10 wt %.

### Example 3

### Measurement of Amount of Carbon Dioxide Discharge of Stretch Film

In order to obtain an amount of carbon dioxide discharged during combustion of the stretch film, the weight of a combustion residue remaining after combustion of a stretch film having carbon dioxide absorbing agent added and a stretch film without carbon dioxide absorbing agent added were measured via a TG/DTA method based on ISO7111, the weights were compared, and an amount of reduction due to a change in an amount of carbon dioxide discharged was calculated.

TABLE 2
Table 2: Reduction in amount of carbon dioxide discharged by
combustion of stretch film

| Carbon dioxide | |
|---|---|
| absorbing substance | Amount of carbon dioxide |
| content | reduction |
| (wt %) | (%) |
| 0 | 0.0 |
| 0.1 | 38.9 |
| 3 | 60.5 |
| 5 | 65.2 |
| 10 | 67.1 |

It was found that a stretch film of the present disclosure may effectively reduce an amount of discharge of carbon dioxide by combustion.

1. A stretch film comprising:
a thermoplastic resin composition having a thickness in a range of 5 to 50 μm, the thermoplastic resin composition containing a carbon dioxide absorbing substance selected from the group consisting of: metal hydroxide, metal oxide, aluminum silicate salt, titanic acid compound, lithium silicate salt, and mixture of two or more thereof, the carbon dioxide absorbing substance included in an amount in a range of 0.1 to 10 wt %.

2. The stretch film according to claim 1, wherein the thermoplastic resin is selected from the group consisting of: polyolefin, polyester, polyvinyl chloride, ethylene-vinyl acetate copolymer, and a mixture of two or more thereof.

3. A method of producing a stretch film, comprising:
producing a thermoplastic resin composition by mixing a thermoplastic resin selected from the group consisting of: polyolefin, polyester, polyvinyl chloride, ethylene-vinyl acetate copolymer, and a mixture of two or more thereof, with a carbon dioxide absorbing substance in an amount in a range of 0.1 to 10 wt %; and
forming the thermoplastic resin composition to a thickness in a range of 5 to 50 μm by an inflation molding method.

4. The method according to claim 3, wherein the carbon dioxide absorbing substance is selected from the group consisting of: metal hydroxide, metal oxide, aluminum silicate salt, titanic acid compound, lithium silicate salt, and a mixture of two or more thereof, and the carbon dioxide absorbing substance is mixed with the thermoplastic resin such that the carbon dioxide absorbing substance is incorporated into a lipid bilayer of an amphipathic lipid.

5. A stretch film produced by the production method according to claim 3.

6. A stretch film produced by the production method according to claim 4.

7. A method of producing a stretch film, comprising:
producing a thermoplastic resin composition by mixing a thermoplastic resin selected from the group consisting of: polyolefin, polyester, polyvinyl chloride, ethylene-vinyl acetate copolymer, and a mixture of two or more thereof, with a carbon dioxide absorbing substance in an amount in a range of 0.1 to 10 wt %; and
forming the thermoplastic resin composition to thickness in a range of 5 to 50 μm by a T-die method.

8. The method according to claim 7, wherein the carbon dioxide absorbing substance is selected from the group consisting of: metal hydroxide, metal oxide, aluminum silicate salt, titanic acid compound, lithium silicate salt, and a mixture of two or more thereof, and the carbon dioxide absorbing substance is mixed with the thermoplastic resin such that the carbon dioxide absorbing substance is incorporated into a lipid bilayer of an amphipathic lipid.

9. A stretch film produced by the production method according to claim 7.

10. A stretch film produced by the production method according to claim 8.
